(19) United States
(12) Patent Application Publication
(10) Pub. No.: US 2015/0372286 A1
(43) Pub. Date: Dec. 24, 2015

(54) APPARATUS FOR MATERIAL SPRAY DEPOSITION OF HIGH SOLID PERCENTAGE SLURRIES FOR BATTERY ACTIVE MATERIAL MANUFACTURE APPLICATIONS

(71) Applicant: APPLIED MATERIALS, INC., Santa Clara, CA (US)

(72) Inventors: Hooman BOLANDI, San Jose, CA (US); Mahendra C. ORILALL, Santa Clara, CA (US); Ajey M. JOSHI, San Jose, CA (US); Connie P. WANG, Mountain View, CA (US); Robert Z. BACHRACH, Burlingame, CA (US)

(21) Appl. No.: 14/763,789

(22) PCT Filed: Mar. 4, 2014
(86) PCT No.: PCT/US14/20410

§ 371 Date: Jul. 27, 2015

Related U.S. Application Data
(60) Provisional application No. 61/786,918, filed on Mar. 15, 2013.

(51) Int. Cl. H01M 4/04; H01M 4/139; B05B 5/025; B05B 1/06; B05B 13/02

(52) U.S. Cl. CPC H01M 4/0419; B05B 1/06; B05B 13/0221; B05B 5/0255; H01M 4/0404; H01M 4/0471; H01M 4/139

(57) ABSTRACT

A method and apparatus for forming battery active material on a substrate are disclosed. In one embodiment, an apparatus for depositing a battery active material on a surface of a substrate includes a substrate conveyor system, the material electrospray dispenser assembly disposed above the substrate conveyor system, and a first heating element disposed adjacent to the material spray assembly above the substrate conveyor system.

### BACKGROUND OF THE INVENTION

1. Field of the Invention

Embodiments of the present invention relate generally to high-capacity energy storage devices and methods and apparatus for fabricating high-capacity energy storage devices. More specifically, methods and apparatus for material spray deposition of high solid percentage slurries for forming battery active materials are disclosed.

2. Description of the Related Art

High-capacity energy storage devices, such as lithium-ion (Li-ion) batteries, are used in a growing number of applications, including portable electronics, medical devices, transportation, grid-connected large energy storage, renewable energy storage, and uninterruptible power supplies (UPS).

Li-ion batteries typically include an anode electrode, a cathode electrode and a separator positioned between the anode electrode and the cathode electrode. Lithium is stored in the active materials in the electrodes. The active electrode material in the positive electrode of a Li-ion battery is typically selected from lithium transition metal oxides, such as LiMn₂O₄, LiCoO₂, LiFePO4, LiNiO₂, or combinations of Ni, Li, Mn, and Co oxides and includes electroconductive particles, such as carbon or graphite, and binder material. Graphite and MCMB (meso carbon micro beads) are usually used as the active electrode material of the negative electrode having a mean diameter of approximately 10 μm. The lithium-intercalation MCMB or graphite powder is dispersed in a polymeric binder matrix. The typical polymers for the binder matrix include PVDF (Polyvinylidene fluoride), SBR (Styrene-Butadiene Rubber), CMC (Carboxymethyl cellulose). The polymeric binder serves to bind together the active material powders to preclude crack formation and prevent disintegration of the active material powder on the surface of the current collector, as well as for good adhesion to the substrate. The quantity of polymeric binder may be in the range of 2% to 30% by weight. The separator of Li-ion batteries is typically made from microporous polyolefin polymer, such as polyethylene foam, and is applied in a separate manufacturing step.

For most energy storage applications, the charge time and capacity of energy storage devices are important parameters. In addition, the size, weight, and/or expense of such energy storage devices can be significant limitations.

One method for manufacturing anode electrodes and cathode of electrodes for energy storage devices is principally based on slit coating of viscous solvent-based powder slurry mixtures of cathodically or anodically active material onto a conductive current collector followed by prolonged heating to form a dried cast sheet. A slow drying process is needed in order to prevent cracking in thick coatings and as a result, the length of the dryers needed are very long. The thickness of the electrode after drying which evaporates the solvents is finally determined by compression or calendering which adjusts the density and porosity of the final layer. Slit coating of viscous slurries is a highly developed manufacturing technology which is very dependent on the formulation, formation, and homogenation of the slurry. The formed active layer is extremely sensitive to the rate and thermal details of the drying process.

Among other problems and limitations of this technology is the slow and costly drying component which requires both a large footprint (e.g., up to 70 to 90 meters long) at coating speeds 5-40 meters/min, and an elaborate collection and recycling system for the evaporated volatile components. Many of these are volatile organic compounds which additionally require an elaborate abatement system. Further, the resulting electrical conductivity of these types of electrodes also limits the thickness of the electrode and thus the energy density of the battery cells.

Accordingly, there is a need in the art for high volume, cost effective manufacturing processes and apparatus for manufacturing high-capacity energy storage devices.

### SUMMARY OF THE INVENTION

Embodiments described herein include a material spray deposition system including at least a substrate conveyor system and a electrode forming solution dispenser. In one embodiment, an apparatus for depositing a battery active material on a surface of a substrate includes a substrate conveyor system, a material spray assembly disposed above the substrate conveyor system, and a first heating element disposed adjacent to the material spray assembly above the substrate conveyor system.

In another embodiment, the spray deposition is electrospray.

In another embodiment, a material electrospray assembly used in an apparatus for depositing a battery active material on a surface of a substrate includes a manifold having a plurality of nozzles formed therein, at least one dummy nozzle formed in the plurality of nozzles formed in the manifold, and an extractor plate coupled to the manifold, wherein the extractor plate further comprises a plurality of apertures formed in the extractor plate aligning with the nozzles formed in the manifold.

In yet another embodiment, a method for depositing a battery active material on a surface of a substrate includes depositing battery active materials from a material electrospray dispenser assembly onto a substrate disposed in a substrate conveyor system; and heating the deposition materials disposed on the substrate by a plurality of heaters disposed above the substrate conveyor system adjacent to the material electrospray dispenser assembly. The substrate may be in web form continuous supplied in the substrate conveyor system, or be one of a plurality of discrete substrates moving through the substrate conveyor system.

In another embodiment, a tip of the nozzle is coated with hydrophobic coating.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1D are schematic diagrams of apparatuses for material spray deposition system for forming a battery-active material layer on a substrate according to different embodiments of the present invention;

FIG. 2A is a schematic diagram of a material spray dispenser assembly disposed in the material spray deposition system depicted in FIGS. 1A-D for dispensing a battery-active material layer according to one embodiment of the present invention;

FIG. 2B is a bottom view of a material spray dispenser assembly depicted in FIG. 2A for dispensing a battery-active material layer according to one embodiment of the present invention;

FIG. 3 is a schematic diagram of a material spray dispenser assembly with edge rings disposed therein for forming a battery-active material layer on a substrate according to another embodiment of the present invention;

FIG. 4 is a schematic diagram of a material spray dispenser assembly with angled nozzles disposed therein for forming a battery-active material layer on a substrate according to another embodiment of the present invention;

FIG. 5 is a schematic diagram of a material spray dispenser assembly with an tilted plate disposed therein for depositing a battery-active material layer on a substrate according to another embodiment of the present invention; and

FIGS. 6A-6B are cross sectional view of nozzles used in a material spray dispenser assembly for forming a battery-active material layer on a substrate according to another embodiment of the present invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The methods and apparatus described herein include a material spray deposition system including at least a substrate conveyor system and a material deposition spray assembly disposed adjacent the substrate conveyor system. The material spray assembly includes nozzles configured to deposit material having good center to edge thickness uniformity, good homogeneity through the film thickness, and to enable rapid deposition rates. The material spray deposition system is particularly useful in depositing material layer(s) utilized for electrode structures, such as battery active material layers, from high solid content electrode forming solutions.

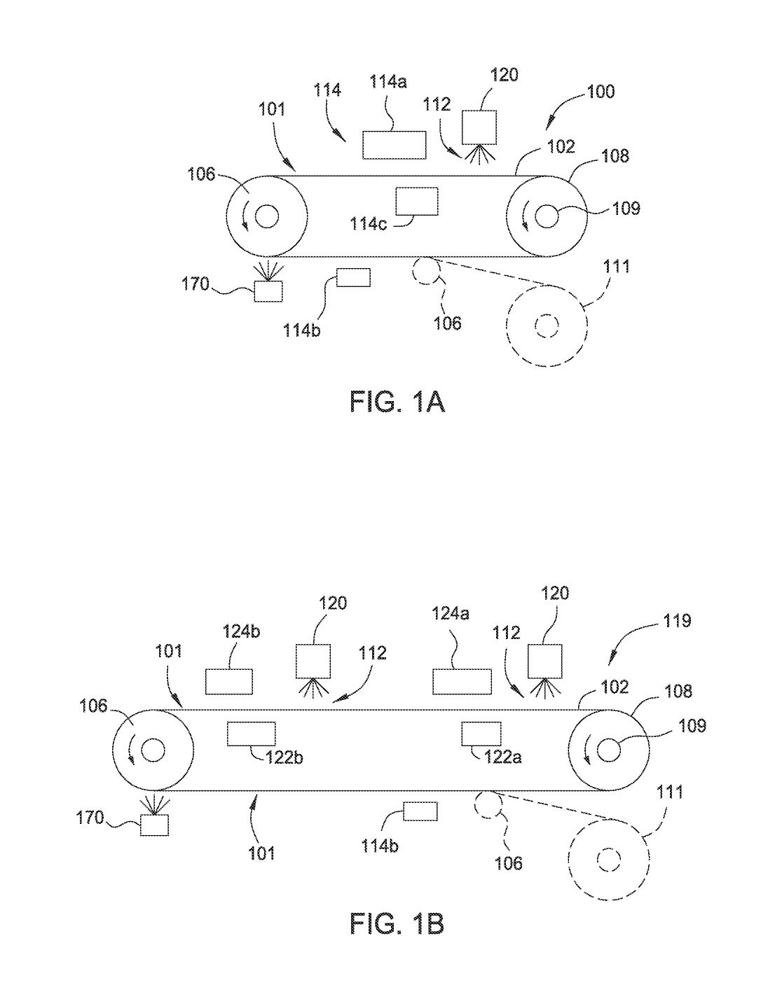

FIGS. 1A-1D are schematic diagrams of material spray deposition systems for depositing a battery-active material layer on a substrate according to different embodiments of the present invention. It is contemplated that aspects of the invention, such as the electrode forming solution, such be adapted for use in other spray deposition systems. FIG. 1A depicts a material spray deposition system 100 with a material electrospray dispenser assembly 110 disposed above a substrate conveyor system 101. The substrate conveyor system 101 may have one or more substrates 102 disposed therein. A top of the substrate 102 defines the deposition surface 104 which is passed adjacent the material electrospray dispenser assembly 110 to enable material to be sprayed onto the substrate 102. The substrate 102 may be in the form of a pad, a foil, a thin plate, a film, a belt or a web. For example, the substrate conveyor system 101 may be configured to simultaneously move a plurality of discrete substrates 102 through the material spray deposition system 100, or alternatively move a single substrate 101 that is in web form. In the embodiments depicted in FIGS. 1A-D, the substrate 102 may be in the form of a belt or web fabricated from a metallic foil having a thickness that generally ranges from about 6 to about 50 μm. In one embodiment, the substrate 102 is aluminum foil in a web form.

The substrate conveyor system 101 includes a supply roll 108, at least one conveying roller 106, and optionally, a take-up roll 111. The conveying roller may optionally be heated to assist drying deposition materials on the substrate 102. The supply roll 108 that contains at least a portion of substrate 102 wound on a core 109. The substrate 102 is fed from the supply roll 108 across to the conveying roller 106 to expose the deposition surface 104 of the substrate 102 adjacent the material electrospray dispenser assembly 110. The substrate 102 may be spliced to itself to form a continuous web so that a given region of the substrate 102 may be passed under the material electrospray dispenser assembly 110 multiple times until a desired thickness of material has been deposited on the substrate 102. Alternatively, the substrate 102 may be routed from the supply roll 108 and passed under the material electrospray dispenser assembly 110 a single time prior to collecting on the take-up roll 111, as shown in phantom.

The supply roll 108 is removable from the substrate conveyor system 101 to facilitate loading another supply roll containing substrate materials for processing when needed. The supply roll 108 may be replaced once deposition materials with desired thickness are formed on the substrate 102. After processing, the substrate 102 may be rewound on the supply roll 108 for removal from the substrate conveyor system 101, if a separate take-up roll 111 is not utilized.

The material electrospray dispenser assembly 110 is utilized to spray deposit deposition materials on the substrate 102, for example, using an electrospray process. The deposition materials deposited on the substrate 102 may be a battery-active material layer. More specifically in the embodiment depicted in FIG. 1, the material electrospray dispenser assembly 110 is positioned above the substrate 102 and is configured to spray deposition materials (i.e., electrode forming solution 112) onto the substrate 102. The material electrospray dispenser assembly 110 may be located in various positions within the material spray deposition system 100, as shown in the different embodiments depicted in FIGS. 1B-1D. The material electrospray dispenser assembly 110 is configured to supply, for example, electrospray, the electrode forming solution 112 distributed across the entire width the substrate 102 in a single pass so as to deposit the battery-active material layer with uniform thickness and surface roughness across the substrate 102. Details of exemplary configurations of the material electrospray dispenser assembly 110 are discussed further below.

In the embodiment depicted in FIG. 1A, a plurality of heaters 114 (shown as 114a, 114b, 114c) may be distributed within the material spray deposition system 100 to more efficiently dry the deposited material either for collection or subsequent deposition of additional material for increasing the thickness of the deposited layer. The heater 114 may assist drying out the electrode forming solution 112 sprayed onto the substrate 102 so as to enhance adhesion of the electrode forming solution 112 to the substrate 102, and to ensure that the electrode forming solution 112 dries uniformly into a homogeneous layer (i.e., no trapped volatiles residual from the solution 112). In the embodiment depicted in FIG. 1A, a first heater 114a may be disposed adjacent to the material electrospray dispenser assembly 110 close to where the substrate 102 is unrolled from the supply roll 108. As the electrode forming solution 112 is sprayed onto the substrate surface 104, the thermal energy from the first heater 114a may assist drying out and evaporating the volatiles from the electrode forming solution 112. A second heater 114c may be disposed on the side of the substrate 102 opposite the first heater 114a. The second heater 114c may also assist drying the electrode forming solution 112 sprayed onto the substrate 102. A third heater 114b may be disposed close to the supply roll 108 (or optional take-up roll 111) after the material has been deposited on the substrate 102 to avoid the substrate 102 sticking to itself upon collection in a roll. It is noted that the number, locations, and configurations of the heaters disposed in the material spray deposition system 100 may be varied as desired.

In one embodiment, the heater 114 may provide light radiation to heat the substrate 102. The light radiation from the heater 114 (i.e., thermal energy) may be used to control the temperature of the substrate 102 to between about 10 degrees Celsius and about 250 degrees Celsius.

An air knife 170 may be disposed at a position adjacent to the supply roll 108 to assist blowing off contaminants or residuals present on the substrate 102 before being taken up by the take-up roll 111 or passing again below material electrospray dispenser assembly 110 for subsequent deposition of additional deposited material. The air knife 170 may provide air or other gas at a predetermined flow rate as needed to substrate surface passing thereby to blow off contaminant or residuals from the substrate 102. The air provided by the air knife 170 may optionally be heated, for example, to between about 10 degrees Celsius and about 250 degrees Celsius, to further assist in drying the deposited material disposed on the substrate 102.

FIG. 1B depicts a schematic diagram of a material spray deposition system 119 for depositing a battery-active material layer on the substrate 102 according to another embodiment of the present invention. Similar to the embodiment depicted in FIG. 1A, the material spray deposition system 119 in FIG. 1B includes the substrate conveyor system 101 disposed therein. Unlike the material electrospray dispenser assembly 110 depicted in FIG. 1A, the material spray deposition system 119 in FIG. 1B includes a plurality of material electrospray dispenser assemblies 120 so as to deposit more material (i.e., a greater thickness) on the surface of the substrate 102 in a single pass. By utilizing the material spray deposition system 119 having multiple material electrospray dispenser assemblies 120, more deposition material, such as a battery-active material layer, uniformly deposited the substrate 102 in less time utilizing a small tool footprint.

Additionally, the use of multiple material electrospray dispenser assemblies 120, each depositing a thin layer, permits each thin layer to be thoroughly dried prior to deposition of the next thin layer. The resulting thicker layer of deposited material has a uniform composition therethrough because volatiles cannot become trapped in the center of the deposition material, which sometimes is the case in bulk or other rapidly deposited layers. Moreover, as the thin layer dry quickly, the thickness of the deposited material may be built up more rapidly than thickly deposited layers which require substantial time to allow for volatiles to be evaporated completely from the film. Accordingly, the material spray deposition system 119 with multiple material electrospray dispenser assemblies 120 allows for increased deposition throughput and efficiency. It is noted that the number of the material electrospray dispenser assemblies 120 utilized in the material spray deposition system 119 may vary as needed to facilitate deposition efficiency and performance.

A first plurality of heaters 124a, 124b may be disposed adjacent to the material electrospray dispenser assemblies 120 above the substrate 102 to assist drying the electrode forming solution 112 sprayed onto the substrate 102. In the embodiment depicted in FIG. 1B, the heaters 124a, 124b are disposed between the material electrospray dispenser assemblies 120. By such arrangement, the electrode forming solution 112 sprayed from the material electrospray dispenser assembly 120 may be rapidly dried and thermally processed by the heaters 124a, 124b disposed adjacent the electrospray dispenser assembly 120. Furthermore, a second plurality of heaters 122a, 122b, may be disposed below the substrate 102 on the opposite side of where the first plurality of heaters 124a, 124b are located. The second plurality of heaters 122a, 122b operate similarly to the first plurality of heaters 124a, 124b. Similar to the structure of the material spray deposition system 100 configured in the FIG. 1A, the third heater 114b may be disposed close to the take-up roll 111 where the substrate 102 is being collected after the deposition process in the material spray deposition system 119 depicted in FIG. 1B. It is noted that the numbers, locations, and configurations of the heaters disposed in the material spray deposition system 119 may be varied as needed.

FIG. 1C depicts a schematic diagram of another material spray deposition system 185 for depositing a battery-active material layer on the substrate 102 with a substrate conveyor system 152 defining various horizontal planes for transferring the substrate 102. A first plurality of conveying rollers 158 (shown as 158a, 158b, 158c and 158d) may be disposed and aligned in the substrate conveyor system 153 defining a first horizontal plane 194. A second plurality of conveying rollers 159 (shown as 159a and 159b) may be aligned and disposed below the first plurality of conveying rollers 158 defining a second horizontal plane 196. In the embodiment depicted in FIG. 1C, the first plurality of conveying rollers 158 include four rollers 158a, 158b, 158c, 158d and the second plurality of conveying rollers 159 include two rollers 159a, 159b. The first horizontal plane 194 defined by the first plurality of conveying rollers 158, such as between the rollers 158b and 158c, may define a horizontal path 164 for the substrate 102 to pass under at least one material electrospray dispenser assembly 120 during the deposition process. The first and second horizontal planes 194, 196, respectively defined by the first plurality of conveying rollers 158a-158d and the second plurality of conveying rollers 159a-159b, may create a substantially extended vertical path 162, such as between rollers 158 and 159. The extended vertical path 162 may increase a total distance that the substrate 102 travels in the substrate conveyor system 152, thereby increasing the drying time without significant increase in the length of the material spray deposition system 185. A first plurality of heaters 156 may be disposed under the extended vertical path 162 to assist heating the substrate 102 after materials dispensing onto the substrate 102. A second plurality of heaters 192 may be optionally disposed above the extended vertical path 162 to heat the substrate 102 as needed. It is noted that the locations, configurations, and numbers of the heaters 156, 192 disposed in the material spray deposition system 185 may be varied in any arrangement as needed.

The substrate 102 is sequentially routed through each of the conveying rollers 158a, 159a, 158b, 158c, 159b, 158d, creating a tortuous (i.e., serpentine) path through the vertical path 162 and the horizontal path 164, thereby extending the total length of time the substrate 102 travels through the system 185. The tortuous path created by the substrate conveyor system 152 may provide increased locations for positioning additional material electrospray dispenser assemblies 120, thereby improving the deposition efficiency without increasing footprint of the substrate conveyor system 103, and desirably reducing the cost of manufacture.

FIG. 1D depicts a schematic diagram of another material spray deposition system 195 for depositing a battery-active material layer on the substrate 102 with a substrate conveyor system 153 defining at least one substantially vertical plane 188 for transferring the substrate 102 in an upward or downward direction. The material spray deposition system 195 is generally configured similar to the systems described above, except wherein at least one material electrospray dispenser assembly 120 is positioned to deposit material on the substrate 102 while the substrate is moving substantially vertically within the substantially vertical plane 188. Additional optional material electrospray dispenser assemblies 120 are shown in phantom to illustrate who the material spray deposition system 195 may be alternatively configured by incorporation of one or more of the optional material electrospray dispenser assemblies 120 in either the same vertical plane, a second substantially vertical plane, and/or on one or more horizontal planes, thereby improving the deposition efficiency without increasing footprint of the substrate conveyor system 103, and desirably reducing the cost of manufacture.

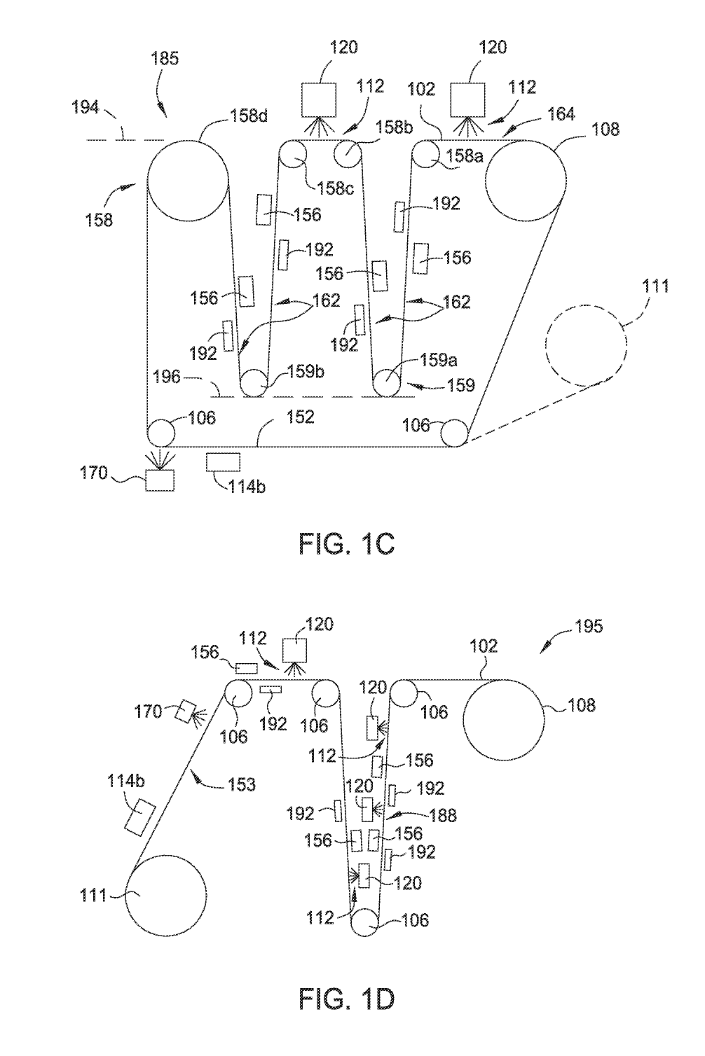

FIG. 2A depicts a schematic diagram of a material electrospray dispenser assembly 200 that can be used in the material spray deposition system 100, 119, 185, 195 depicted in FIG. 1A-1D. The material electrospray dispenser assembly 200 may be similarly configured as the material electrospray dispenser assembly 110, 120 disposed in the material spray deposition system 100, 119, 185, 195. The material electrospray dispenser assembly 200 includes a manifold 202 having a top surface 216 and a lower surface 214. A plurality of nozzles 204 is coupled to the manifold 202 from the lower surface 214 thereof. The lower surface 214 of the manifold 202 is substantially parallel to the portion of the substrate 102 positioned thereto, while in most embodiments, at least some of the nozzles 204 are oriented perpendicular to both the lower surface 214 and adjacent surface of the substrate 102. A fluid passage 282 may be formed on the top surface 216 of the manifold 202 to supply deposition material (i.e., electrode forming solution) from a deposition material source 280. In one embodiment, the manifold 202 may be fabricated by a conductive material, such as aluminum, stainless steel, tungsten, copper, molybdenum, nickel, alloys thereof, combinations thereof, other suitable metal material or the like.

The electrode forming solution 112 supplied from the deposition material source 280 may comprise an electro-active material and an electro-conductive material. The electro-active material and the electro-conductive material may be in a water-based solution. The electrode forming solution 112 may also include a solvent, such as N-Methylpyrollidone (NMP), or other suitable solvent or water. The electrode forming solution 112 may optionally include at least one of a binding agent and a drying agent. The electrode forming solution 112 may have a baseline conductivity of at least about 10⁻⁵ Siemens/meter.

Exemplary electro-active materials which may be deposited using the embodiments described herein include but are not limited to cathodically active particles selected from the group comprising lithium cobalt dioxide (LiCoO₂), lithium manganese dioxide (LiMnO₂), titanium disulfide (TiS₂), LiNixCo₁₋₂ₓMnO₂, LiMn₂O₄, iron olivine (LiFePO₄) and it is variants (such as LiFe₁₋ₓMgPO₄), LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, other qualified powders, composites thereof and combinations thereof.

Other exemplary electro-active materials which may be deposited using the embodiments described herein include but are not limited to anodically active particles selected from the group comprising graphite, graphene hard carbon, carbon black, carbon coated silicon, tin particles, copper-tin particles, tin oxide, silicon carbide, silicon (amorphous or crystalline), silicon alloys, doped silicon, lithium titanate, any other appropriately electro-active powder, composites thereof and combinations thereof.

Exemplary drying agents include, but are not limited to, isopropyl alcohol, methanol, and acetone. Exemplary binding agents include, but are not limited to, polyvinylidene difluoride (PVDF) and water-soluble binding agents, such as styrene butadiene rubber (SBR) and sodium carboxymethyl cellulose (CMC). Exemplary electro-conductive materials include, but are not limited to, carbon black (“CB”) and acetylene black (“AB”).

The electrode forming solution may have a solids content greater than 30 percent by weight (wt. %), such as between about 30 wt. % and about 85 wt. %. In one embodiment, the electrode forming solution may have a solids content of between about 40 wt. % and about 70 wt. %, such as between about 50 wt. % and about 60 wt. %.

Conventionally, electrospray technology is limited for use with solid-free liquids or liquids containing particles less than 1 micrometer. The embodiments described herein enables electrospraying of solutions having much larger particle sizes. The solids within the electrode forming solution generally have a particle size larger than conventional depositions systems, thereby allowing higher deposition rates. For example, solid particles within the electrode forming solution may have a mean diameter in the range of between about 1.0 μm to about 20.0 μm, such as between about 3.0 μm to about 15.0 μm. The solids present in the electrode forming solution comprise at least one or both of active material and conductive material. The only known technology which can utilized such large particle size for battery active material deposition are slit coating systems which are as discussed above, suffer from long drying times and film cracking, and additionally suffer from poor thickness uniformity control, making slit coating systems undesirable for next generation battery devices. As described herein, the material electrospray dispenser assembly 200 enables rapid deposition of high solid content battery active materials with good uniformity control in a system having a cost effective, smaller footprint with no film cracking problems, thereby enhancing development and fabrication of next generation battery devices.

An optional extractor plate 206 having a plurality of apertures 208 may be formed therein aligning with the nozzles 204 extending in the manifold 202. The extractor plate 206 may have an upper surface 212 facing the manifold 202 and a lower surface 210 facing the substrate 102. The upper surface 212 of the extractor plate 206 may be parallel to the lower surface 214 of the manifold 202. The extractor plate 206 may be coupled to the manifold 202 using suitable mechanical attachments, such as screws or bolts, adhesive materials or any other suitable attachment techniques. The plurality of apertures 208 in the extractor plate 206 may reactively align with the nozzles 204 coupled to the manifold 202 so as to facilitate and confine flow of the deposition materials from the deposition material source 280 to the substrate 102. In one embodiment, the lower surface 214 of the manifold 202 may have a distance 250 between about 5 mm and about 55 mm to the upper surface 212 of the extractor plate 206. The nozzle 204 may have distance 252 between about 10 mm and about 50 mm to the upper surface 212 of the extractor plate 206.

In one embodiment, the apertures 208 formed in the extractor plate 206 may have a predetermined size to accommodate the flow volume of the deposition material supplied from the nozzles 204. Different sizes of the nozzle 204 may result in different flux of the deposition materials flowing therethrough passing the apertures 208 of the extractor plate 206 to the substrate surface. In one embodiment, the diameter of the apertures 208 may be selected between about 0.3 mm and about 5 mm.

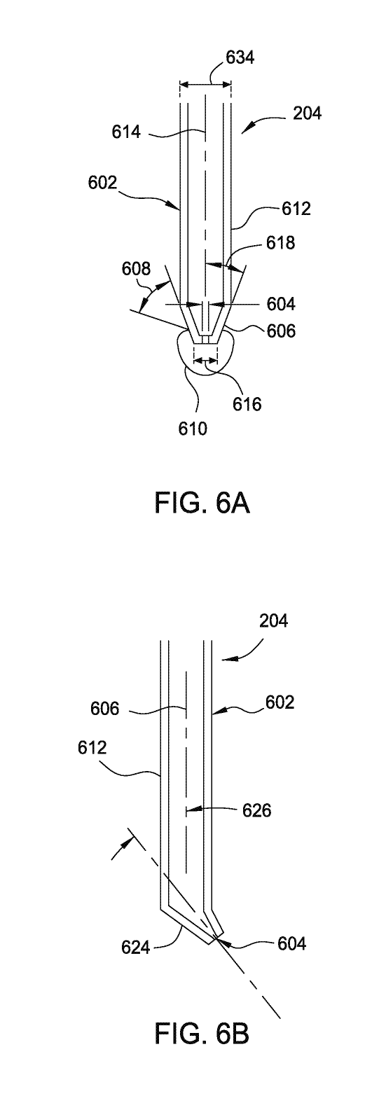

The plurality of nozzles 204 coupled to the manifold 202 may have different configurations, shape, features, and numbers to meet different process requirements. The nozzles 204 and the apertures 208 formed in the extractor plate 206 may collectively form a material path that allows deposition material from the material source 280 to pass therethrough to the substrate 102. In the embodiment depicted in FIG. 2A, the nozzles 204 may be in form of a single straight cylinder, cone shape, square shape, oval shape, or any other different configurations as needed. Details regarding the configurations of the nozzles 204 will be described below with reference to FIGS. 6A-6B.

A first circuit arrangement 232 couples to the material electrospray dispenser assembly 200 to a power source 270. The first circuit arrangement 232 is adapted to provide power to the material electrospray dispenser assembly 200. In operation, the manifold 202 and the extractor plate 206 may each act as an electrode. A first voltage V₁ may be applied to the manifold 202 and the extractor plate 206, establishing a first electric field that atomizes deposition materials passing therethrough. In one embodiment, the first voltage V₁ may be between about 5 KVolts and about 50 KVolts. A second circuit arrangement 234 is coupled between the material electrospray dispenser assembly 200 and the substrate 102. As the substrate 102 is fabricated from a metallic material, such as an aluminum foil, the substrate 102 may also act as an electrode during operation. Similarly, a second voltage V₂ may be applied to the substrate 102 and the extractor plate 206, establishing a second electric field to enable acceleration the atomized electrode forming solutions passing through the apertures 208 in the extractor plate 206 on to the substrate 102. The second voltage V₂ may be between 5 KVolts and about 50 KVolts. The substrate 102 may coupled to ground 230, for example, through one of the rollers 106. The second voltage V₂ may be greater than the first voltage V₁, for example by about 5 KVolts.

In one embodiment, the plurality of the nozzles 204 coupled to the manifold 202 may have an arrangement selected so as to assist deposition materials (i.e., electrode forming solution 112) provided from the deposition material source 280 to be evenly distributed on the substrate 102. In one embodiment, dummy nozzles 218, fabricated from an electrically conductive material, for example a metal such as stainless steel, may be disposed at edges of the manifold 202 to reduce tilting of the spray exiting the outermost nozzles 204 due to an imbalance in the electric field at the last nozzle 204. In some cases, deposition materials supplied through the outermost nozzles 204 disposed at the edges of the manifold 202 may have a tilted spray trajectory compared to the spray trajectory of the inner nozzles 204, thereby adversely impacting the film uniformity at the edge of the substrate 102. In embodiments employing dummy nozzles 218 disposed around ends of the manifold 202 outward of the last nozzle 204, a voltage may be applied to the dummy nozzle 218 to create an electric field with the extractor plate 206 in the same manner as between the nozzles 204 and the extractor plate 206. Thus, the electric field may be uniformly extended laterally outward of the outer most nozzles 204 so that electric fields acting on the spray exiting the center and outer nozzles 204 are substantially the same, thereby allowing the spray trajectory to be essentially uniform (i.e., vertical) between the outermost and center nozzles 204, and enhancing center to edge deposition uniformity on the substrate 102. Although only one dummy nozzle 218 is shown at each end of the manifold 202, it is noted that the dummy nozzles may be coupled to the manifold 202 at any desirable location.

The arrangement of the nozzles 204 within the material spray dispenser assembly 200 allows for greater flow rates of high solid content electrode forming solution, which in conjunction with the high drying rates facilitated by the material spray deposition system 100 or other system described herein, results in fast deposition of homogeneous battery-active materials with uniform center to edge thickness. For example, each nozzle 204 of the material spray dispenser assembly 200 may deliver about 0.15 ml/min to about 15.0 ml/min of high solid content (i.e., greater than 10 wt. %) electrode forming solution.

In the embodiment depicted in FIG. 2A, the material electrospray dispenser assembly 200 may have a width 272 that accommodates a row of nozzles 204. In an exemplary embodiment, the row may include up to about 20 nozzles aligned in a single row. With the nozzles 204 arranged in a single row, the material electrospray dispenser assembly 200 generally produces a spray pattern that covers the entire width 254 of the substrate 102. As such, although the manifold 202 may have a width 272 greater than a the width 254 of the substrate 102, a center to center distance of the outermost nozzles 204 may be slightly less than the width 254 of the substrate 102, while a center to center distance of the dummy nozzles 218 may be slightly greater than the width 254 of the substrate 102 to ensure good edge to center deposition thickness uniformity.

FIG. 2B is a bottom view of the material electrospray dispenser assembly 200 depicted in FIGS. 1A-1D and FIG. 2A. In the embodiment depicted in FIG. 2B, the nozzles 204 of the material electrospray dispenser assembly 200 be may grouped into a plurality of zones, wherein each zone has a different flow attribute, either by the zone as a unit, or by nozzles between different zones. For example, the nozzles 204 of the material electrospray dispenser assembly 200 be may grouped into a center zone 262 disposed between edge zones 260. Each zone 260, 262 of the material electrospray dispenser assembly 200 may differ in the number of nozzles 204, the spacing between nozzles 204, the applied voltage, or the flow rate through the nozzles 204. In one embodiment, the center zone 262 of the material electrospray dispenser assembly 200 may have multiple nozzles 204 while and the edge zones 260 respectively include only a single nozzle 204. Dummy nozzles 218 (not shown in FIG. 2B) may also be present in the edge zones 260 as discussed above.

The arrangement of the nozzles 204 within the material electrospray dispenser assembly 200 allows for greater flow rates of high solid content electrode forming solution, which in conjunction with the high drying rates facilitated by the material spray deposition system 100 or other system described herein, results in fast deposition of homogeneous battery-active materials with uniform center to edge thickness. For example, each nozzle 204 of the material electrospray dispenser assembly 200 may deliver about 0.15 ml/min to about 15.0 ml/min of high solid content (i.e., greater than 10 wt. %) electrode forming solution.

In some embodiments, the flow through the nozzles 204 located in the edge zones 260 may be different, for example greater, than the flow through the nozzles 204 located in the center zone 262. This may be coupled with a less voltage applied to the nozzles 204 located in the edge zones 260 compared to the voltage applied to the nozzles 204 located in the center zone 262, which compensates for tendencies to have faster deposition in the center of the substrate 102, thereby contributing for more uniform edge to center thickness of the deposited battery active material.

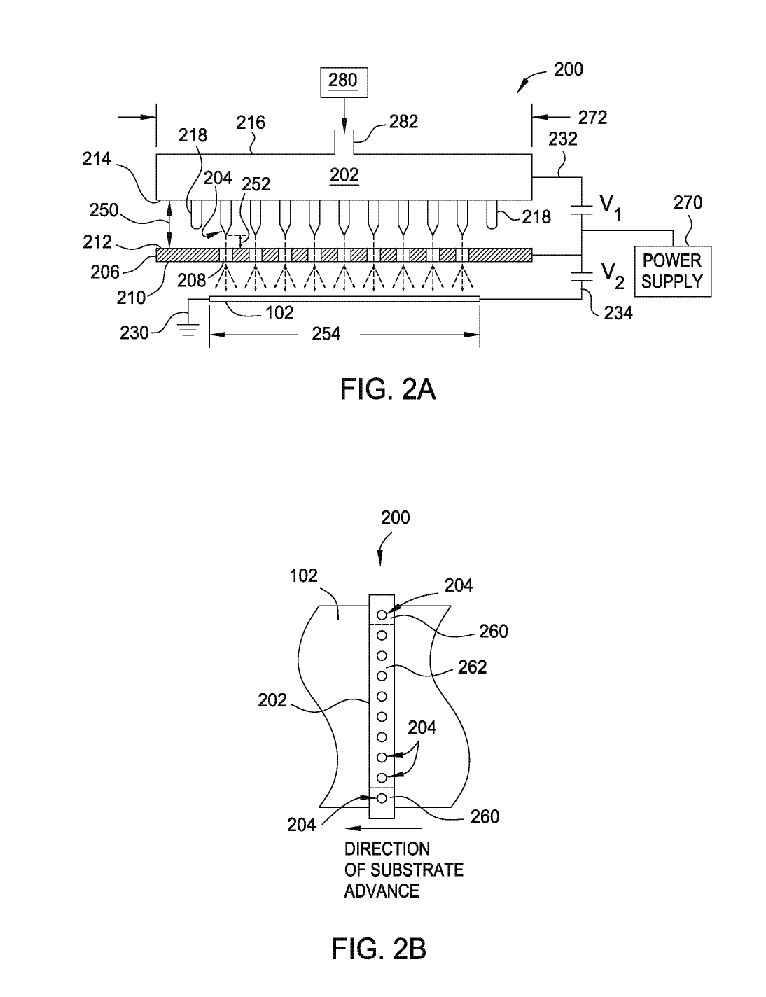

FIG. 3 is a schematic diagram of a material spray dispenser assembly 300 with edge rings 302 disposed at edges 304 of the material spray dispenser assembly 300. The material spray dispenser assembly 300 includes an edge ring 302 disposed on an edge 304 of the extractor plate 206. The edge ring 302 is disposed on the lower surface 210 of the extractor plate 206. In operation, a voltage may be applied to the edge ring 302 to charge the edge ring 302 at the same polarity as the nozzles 204. In one embodiment, the voltage applied to the edge ring 302 may be at the same voltage as the voltage applied to the nozzles 204. By doing so, the charged edge ring 302 may push the deposition material passing through the adjacent apertures 208 of the extractor plate 206 inward, so as to reduce the edge tilting effect. In one embodiment, the edge ring 302 may be a tube having a length substantially similar to the length of the extractor plate 206. In another embodiment, the edge ring 302 may be in a ring form having a hollow body disposed along the edges 304 of the extractor plate 206. The edge ring 302 may have an inner diameter 308 between about 0.5 mm and about 5.0 mm and an outer diameter 312 between about 1 mm and about 20 mm.

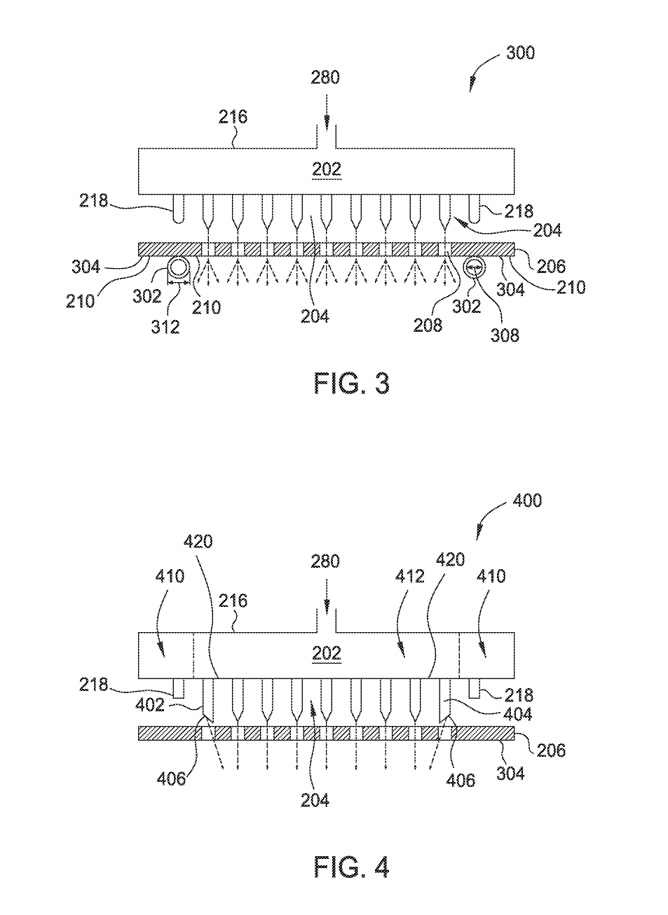

FIG. 4 depicts another embodiment of a material spray dispenser assembly 400 having angled nozzles 204 formed therein. The material spray dispenser assembly 400 is formed by multiple plates to facilitate replacement of nozzles with different configurations at center or edge of the material spray dispenser assembly 400. In one embodiment, the material spray dispenser assembly 400 has a center plate 412 having two edge plates 410 coupled to the two ends of the center plate 412. The edge plate 410 may have one or more dummy nozzles 218 extending therefrom.

In one embodiment, an angled nozzle 406 may be formed at an edge 420 of the center plate 412. It is believed that the angled nozzle 406 may assist directing the deposition material more inward to a center of the substrate 102 so as to reduce the tilting effect of the outermost spray trajectory and thereby improve thickness uniformity of the deposited film formed on the substrate 102. The angled nozzle 406 may be an outermost one of the nozzles coupled to the center plate 412. Alternatively, the angled nozzle 406 may be located in another suitable position in the center plate 412. It is noted that the angled nozzle 406 may also be configured in different configurations, such as cone shape, square shape, oval shape, or other suitable configurations. More details regarding the angled nozzle 406 will be further discussed below with reference to FIG. 6B.

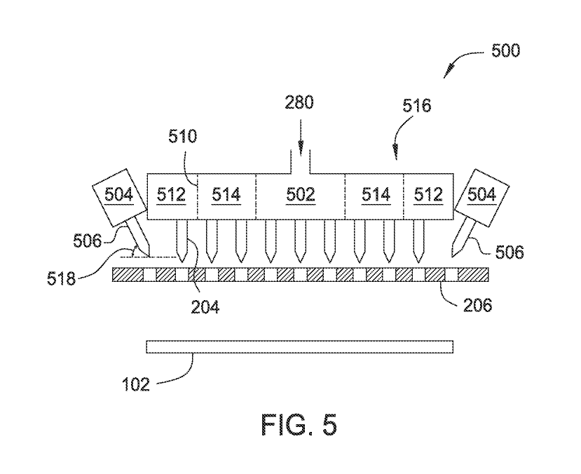

FIG. 5 depicts another embodiment of a material spray dispenser assembly 500 having a tilted plate 504. The tilted plate 504 of the material spray dispenser assembly 500 is coupled to opposite ends of a center plate 516. The tilted plate 504 may have at least one nozzle 506 extending therefrom. Although only one nozzle 506 is shown in FIG. 5A, it is noted that additional nozzles 506 may extend from the tilted plate 504 as needed. As the tilted plate 504 is coupled to the center plate 516 at an angle to a horizontal plane, the deposition materials supplied therefrom are directed in an inward trajectory toward the center of the substrate 102. The deposition materials may be supplied from the deposition material source 280 connected to both the tilted plates 504 and the center plate 516 or from a separate, independently controlled deposition material source. The angle of the tilted plate 504 in the material spray dispenser assembly 500 may be adjusted to control the angle of electrode forming solution exiting the nozzles 506 projected onto the substrate 102 so as to efficiently minimize the edge nozzle effects described above that may impact film uniformity. In one embodiment, the nozzles 506 formed in the edge titled plate 504 may have projecting angle 518 between about 10 degrees and about 60 degrees to a horizontal plane in parallel to the surface of the substrate 102.

FIGS. 6A-6B are cross sectional view of nozzles 204 with different configurations for forming a battery-active material layer on a substrate. In the embodiment depicted in FIG. 6A, the nozzle 204 has a cylindrical body 602 having a cylindrical sleeve 612 coupled to a tip 606. The tip 606 tapers from the cylindrical sleeve 612. The cylindrical sleeve 612 has a first outer diameter 634 and a distal end of the tip 606 has a second outer diameter 616. The second outer diameter 616 is smaller than the first outer diameter 634, thereby defining a taper of the tip 606. In one embodiment, the taper of the tip 606 relative to a centerline of the nozzle 204 is less than about 49 degrees, for example about 45 degrees (having a plus 0 minus 4 degrees tolerance) as illustrated by reference numeral 618.

The deposition material exiting the nozzle 204 may wet and creep up the tip 606 of the nozzle 204, thereby undesirably increasing the diameter of the stream of materials exiting the nozzle, making process control difficult and undesirably increasing potential arcing between nozzles. Selecting a ratio between the first outer diameter 634 and an inside diameter 618 through which the electrode forming solution flows balances the ability to obtain high deposition rates while minimizing the potential for arcing between nozzles. For example, it has been demonstrated that a ratio between the first outer diameter 634 and the inside diameter 618 of 4:1 and 3:1 will provide good deposition results without arcing when nozzles 204 are spaced at distances as close as 12 mm or even 9 mm between nozzle centerlines.

In certain embodiments, the effective diameter of the material exiting from the tip 606 towards the substrate surface may be controlled by a hydrophobic coating applied to an exterior of the tip 306 and/or the body 602 of the nozzle 204 to change (i.e., increase) the contact angle 608 formed between the droplet and the tip 606 of the nozzle 204 and to prevent wetting of the nozzle by the deposition material. In one embodiment, the contact angle 608 may be controlled greater than 20 degrees, such as greater than 30 degrees, for example between about 20 degrees and about 90 degrees. In one embodiment, the hydrophobic coating utilized to coat on the tip 606 may be polytetrafluoroethylene (PTFE), perfluorodecyltrichlorosilane (FDTS) and the like.

It has also been found that fabricating the tip 606 to have a smooth exterior surface will also minimize wetting of the nozzle 204. In one embodiment, the exterior surface of the tip 606 is fabricated to have a surface roughness of about 16 Ra or smoother.

FIG. 6B depicts another embodiment for the nozzle 406, previously depicted in FIG. 4, with an angled tip 624. The nozzle 406 includes cylindrical body 602 having the cylindrical sleeve 612 coupled to the angled tip 624. The angled tip 624 extends from the cylindrical sleeve 612. The angled tip 624 has an angle 626 between about 20 and about 60 degrees from a horizontal plane. The angled tip 624 may be utilized to direct the trajectory of the spray exiting the nozzle, which may be particularly beneficial for nozzles positioned at the edge of the spray dispenser assembly to control the edge to center deposition thickness uniformity.

While the foregoing is directed to embodiments of the invention, other and further embodiments of the invention may be devised without departing from the basic scope thereof.

1. An apparatus for depositing a battery active material on a surface of a substrate comprising:
a substrate conveyor system;
a material spray assembly disposed above the substrate conveyor system; and
a first heating element disposed adjacent to the material spray assembly above the substrate conveyor system.

2. The apparatus of claim 1, wherein the material spray assembly is electrospray assembly which further comprises:
a first nozzle disposed at an edge of the material spray assembly and a second nozzle disposed inward of the first nozzle, the first nozzle having an inward inclination relative to the second nozzle.

3. The apparatus of claim 1, wherein the substrate conveyor system further comprises:
a second heating element disposed in the substrate conveyor system away from the material spray assembly.

4. The apparatus of claim 1, wherein the substrate conveyor system further comprises:
an air knife disposed adjacent to the substrate conveyor system configured to provide air in the substrate conveyor system.

5. The apparatus of claim 1, wherein the material spray assembly further comprises:
a plurality of nozzles having a nozzle density at an edge of the material spray assembly greater than at the center.

6. The apparatus of claim 1, wherein the material spray assembly further comprises:
a manifold having a plurality of nozzles formed therein; and
an extractor plate coupled to the manifold.

7. The apparatus of claim 6, wherein the extractor plate further comprises:
a plurality of apertures formed in the extractor plate aligning with the nozzles formed in the manifold.

8. The apparatus of claim 6, wherein the manifold further comprises:
at least one dummy nozzle formed at an edge of the manifold.

9. The apparatus of claim 6, wherein the plurality of nozzles formed in the manifold further comprises:
an angled nozzles formed at an edge of the manifold.

10. The apparatus of claim 1, wherein the material spray assembly further comprises:
multiple zones formed in the material spray assembly.

11. The apparatus of claim 1, wherein the material spray assembly further comprises:
a hydrophobic coating coated on at least one of the nozzles.

12. The apparatus of claim 6, further comprising:
an edge ring disposed on an edge of the extractor plate.

13. A material spray assembly used in an apparatus for depositing a battery active material on a surface of a substrate comprising:
a manifold having a plurality of nozzles formed therein;
at least one dummy nozzle formed in the plurality of nozzles formed in the manifold; and
an extractor plate coupled to the manifold, wherein the extractor plate further comprises a plurality of apertures formed in the extractor plate aligning with the nozzles formed in the manifold.

14. The material spray assembly of claim 13, further comprises:
an edge ring coupled to an edge of the extractor plate.

15. The material spray assembly of claim 13, wherein the manifold further comprises:
multiple zones formed in the manifold, each zone having different nozzle configuration.

16. The material spray assembly of claim 13, wherein the material spray assembly further comprises:
a center plate;
a tilted plate coupled to the center plate, wherein the tilted plate may have an angle between about 20 degrees and about 60 degrees to a horizontal plane.

17. The material spray assembly of claim 13, wherein the dummy nozzle is formed at an edge of the manifold.

18. The material spray assembly of claim 13, wherein the plurality of nozzles formed in the manifold further comprises:
an angled nozzles formed at an edge of the manifold.

19. The material spray assembly of claim 13, further comprising:
a hydrophobic coating coated on a tip of at least one of the nozzle.

20. A method for depositing a battery active material on a surface of a substrate, comprising:
depositing battery active materials from a material electrospray dispenser assembly onto a substrate disposed in a substrate conveyor system; and
heating the deposition materials disposed on the substrate by a plurality of heaters disposed above the substrate conveyor system adjacent to the material electrospray dispenser assembly.
